(19) United States
(12) Patent Application Publication
(10) Pub. No.: US 2013/0170085 A1
(43) Pub. Date: Jul. 4, 2013

(54) POWER SUPPLY APPARATUS INCLUDING OVERVOLTAGE PROTECTION FUNCTION

(71) Applicants: Jong Hae Kim, Suwon (KR); Deuk Hoon Kim, Suwon (KR); Geun Young Park, Suwon (KR); Young Min Lee, Suwon (KR); Dae Young Hwang, Suwon (KR); Jae Sun Won, Suwon (KR); Myeong Jeong Kim, Suwon (KR); Jeong Myeon Kim, Suwon (KR)

(72) Inventors: Jong Hae Kim, Suwon (KR); Deuk Hoon Kim, Suwon (KR); Geun Young Park, Suwon (KR); Young Min Lee, Suwon (KR); Dae Young Hwang, Suwon (KR); Jae Sun Won, Suwon (KR); Myeong Jeong Kim, Suwon (KR); Jeong Myeon Kim, Suwon (KR)

(73) Assignee: SAMSUNG ELECTRO-MECHANICS CO., LTD.

(21) Appl. No.: 13/614,697

(22) Filed: Sep. 13, 2012

(30) Foreign Application Priority Data
Dec. 28, 2011 (KR) 10-2011-0144825

(51) Int. Cl. H02H 9/04

(52) U.S. Cl. 361/91.1

(57) ABSTRACT

There is provided a power supply apparatus including an overvoltage protection function, the power supply apparatus including: a power supply unit supplying a predetermined input power supply; a rectification unit generating a first power supply by rectifying the input power supply; a main circuit unit generating a second power supply from the first power supply; and an overvoltage blocking unit blocking overvoltages and overcurrents, wherein the overvoltage blocking unit includes varistors connected between at least one of a live line and a neutral line of the input power supply and a ground.

### CROSS-REFERENCE TO RELATED APPLICATIONS

This application claims the priority of Korean Patent Application No. 10-2011-0144825 filed on Dec. 28, 2011, in the Korean Intellectual Property Office, the disclosure of which is incorporated herein by reference.

### BACKGROUND OF THE INVENTION

1. Field of the Invention

The present invention relates to a power supply apparatus having an overvoltage protection function capable of effectively suppressing supplied excessive power such as overvoltage, overcurrent, and the like due to a power surge caused by a lightning strike and other factors.

2. Description of the Related Art

As home, office, and portable electronic devices have become widely varied and increasingly popular, damage thereto, due to power surges, is rapidly increasing. A power surge refers to a transient waveform in a current, a voltage, or the like, having the characteristics of being transferred along a line or a circuit and rapidly increasing in magnitude. A power surge may be caused by a rapid rise in voltages at both ends of an inductor and the opening and closing thereof in view of the interior of a circuit, and may be caused by a natural phenomenon such as a direct lightning strike, an indirect lightning strike, an induced lightning, an electrical discharge in the air, or the like, in view of the exterior of the circuit.

In particular, as circuit integration has been increasing in recent times, a width of a circuit line has been reduced, as a material having low resistance and excellent conductivity has been used to perform low power operations, a relatively maximum value of a short-circuit phenomenon has been reduced, and thus overall systems have low withstanding voltage, and accordingly, these overall systems may be more vulnerable to power surges. Repetition of a weak power surge may deteriorate device performance, and as a result, the device may be destroyed, while a single strong power surge may destroy a device despite occurring only once. Further, in a case in which a surge occurring in a specific circuit part is transferred to another circuit part or a system, the overall system may be serially destroyed in an extreme case. Thus, there is a need to build a power surge protection system to prevent power surges from being transferred so as to substantially reduce damage caused thereby.

To prepare appropriate power surge counter-measures, a device such as a varistor may be generally used. A varistor is a non-linear device disposed on a path by which the power surge can travel. At present it is customary to establish a design necessary for blocking a power surge through a customary measurement, a change in the device, etc. This may lead to over-specification or a waste of developmental costs and time, causing a general increase in product unit cost, deterioration in yield, and the like.

In the following related art documents, Patent Document 1 relates to a power supply apparatus including an overvoltage control function, in which an overvoltage control unit is turned on by an alternating current voltage induced in a coil and controls a path through which an input power supply is transferred, according to an output voltage, and thus, overvoltage may be controlled, while a varistor is not disclosed as being included in a circuit. Also, although Patent Document 2 relates to an overvoltage protection apparatus including a varistor, the varistor is connected between a rear end of a fuse of an input power supply and a rectifier and has a turn-on voltage different from that of a separately prepared overvoltage blocker so that the varistor and the overvoltage blocker may operate organically.

### RELATED ART DOCUMENTS

(Patent Document 1) Korean Patent Laid-Open Publication No. KR 10-2004-0072753
(Patent Document 2) Korean Patent Laid-Open Publication No. KR 10-2002-0092491

### SUMMARY OF THE INVENTION

An aspect of the present invention provides a power supply apparatus including an overvoltage protection function capable of inhibiting overvoltages and overcurrents due to a power surge and reducing levels of power surge voltage and current by placing varistors between at least one of a live line and a neutral line of an input power supply and a ground line or connecting the varistors, an arrestor, or the like between a drain terminal and a source terminal of a switching device of a primary side with respect to a transformer.

According to an aspect of the present invention, there is provided a power supply apparatus including an overvoltage protection function, the power supply apparatus including: a power supply unit supplying a predetermined input power supply; a rectification unit generating a first power supply by rectifying the input power supply; a main circuit unit generating a second power supply from the first power supply; and an overvoltage blocking unit blocking overvoltages and overcurrents, wherein the overvoltage blocking unit includes varistors connected between at least one of a live line and a neutral line of the input power supply and a ground.

The overvoltage blocking unit may include a first varistor connected between the live line of the input power supply and a protective earth and a second varistor connected between the neutral line of the input power supply and the protective earth.

The overvoltage blocking unit may form a discharge path and reduce power surge voltage caused by a lightning strike.

The main circuit unit may include a flyback converter including at least one transformer.

The overvoltage blocking unit may include a circuit connected between a drain terminal and a source terminal of a switching device disposed on a primary side of the at least one transformer and controlling the overvoltages.

The circuit connected between the drain terminal and the source terminal and controlling the overvoltages may include at least one of a varistor, an arrestor, and a capacitor.

According to another aspect of the present invention, there is provided a power supply apparatus including an overvoltage protection function, the power supply apparatus including: a power supply unit supplying a predetermined input power supply; a main circuit unit including at least one transformer and generating output power supply from the input power supply; and an overvoltage blocking unit blocking overvoltages and overcurrents that occur in the main circuit unit, wherein the overvoltage blocking unit includes at least one of a varistor, an arrestor, and a capacitor to control overvoltages and overcurrents transferred to a switching device included in a primary side of the at least one transformer.

The overvoltage blocking unit may include at least one of the varistor, the arrestor, and the capacitor that are connected between a drain terminal and a source terminal of the switching device included on the primary side of the at least one transformer.

The main circuit unit may include a flyback converter circuit.

The overvoltage blocking unit may form a discharge path and reduce a power surge voltage caused by a lightning strike when a power surge occurs due to the lightning strike.

The overvoltage blocking unit may block a power surge current or the power surge voltage from being transferred between the primary side and a secondary side of the at least one transformer when the power surge occurs due to the lightning strike.

The overvoltage blocking unit may include varistors connected between at least one of alive line and a neutral line of the input power supply and a ground.

The overvoltage blocking unit may include a first varistor connected between the live line of the input power supply and a protective earth and a second varistor connected between the neutral line of the input power supply and the protective earth.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a power supply apparatus including an overvoltage protection function according to an embodiment of the present invention;

FIGS. 2 and 3 are circuit diagrams of signal paths of overvoltage or overcurrent that may occur in a power supply apparatus including an overvoltage protection function according to embodiments of the present invention; and

FIGS. 4 and 5 are schematic circuit diagrams of examples of an overvoltage blocking unit included in a power supply apparatus including an overvoltage protection function according to embodiments of the present invention.

### DETAILED DESCRIPTION OF THE EMBODIMENTS

Embodiments of the present invention will be described in detail with reference to the accompanying drawings. These embodiments will be described in detail for those skilled in the art in order to practice the present invention. It should be appreciated that various embodiments of the present invention may be different and are not necessarily exclusive. For example, specific shapes, configurations, and characteristics described in an embodiment of the present invention may be implemented in another embodiment thereof without departing from the spirit and the scope of the present invention. In addition, it should be understood that the position and arrangement of individual components in each disclosed embodiment may be changed without departing from the spirit and the scope of the present invention. Therefore, a detailed description described below should not be construed as being restrictive. In addition, the scope of the present invention is defined only by the accompanying claims and their equivalents when appropriate. Similar reference numerals will be used to describe the same or similar functions throughout the accompanying drawings.

Hereinafter, embodiments of the present invention will be described in detail with reference to the accompanying drawings so that those skilled in the art may easily practice the present invention.

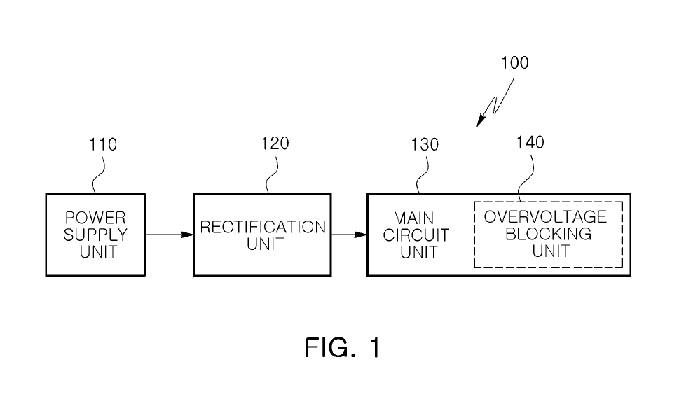

FIG. 1 is a schematic block diagram of a power supply apparatus 100 including an overvoltage protection function according to an embodiment of the present invention.

Referring to FIG. 1, the power supply apparatus 100 according to the present embodiment may include a power supply unit 110, a rectification unit 120, and a main circuit unit 130. Although an overvoltage blocking unit 140 is included in the main circuit unit 130 in the present embodiment, the overvoltage blocking unit 140 may be disposed in the power supply unit 110. The power supply unit 110 may generate and output a general alternating current power supply. The rectification unit 120 may rectify and smooth the alternating current power output by the power supply unit 110 and may convert it into a direct current signal. The rectification unit 120 may be implemented as a plurality of diodes. The power supply unit 110 may include a fuse that shuts down when overvoltage is applied thereto to protect an overall system, a plurality of capacitors and inductors, and the like.

The main circuit unit 130 generates an output signal used to drive an electronic device, from the direct current signal that is rectified, smoothed, and output by the rectification unit 120. As an embodiment, in a case in which the power supply apparatus 100 is a switch mode power supply (SMPS) apparatus, the main circuit unit 130 may include a flyback converter that converts the direct current signal output by the rectification unit 120 into an output signal used to drive the electronic device.

The flyback converter may include at least one transformer, and divide circuits into a primary side and a secondary side with respect to the transformer. The primary side and the secondary side of the transformer may be electrically insulated. In particular, in a case in which the primary side and the secondary side of the transformer are not sufficiently electrically insulated, an overvoltage or an overcurrent caused by a power surge occurring on the secondary side of the transformer is likely to be transferred to the primary side through the transformer and adversely affect even the rectification unit 120 or the power supply unit 110.

Likewise, when the primary side and the secondary side of the transformer are not sufficiently electrically insulated, an overvoltage or an overcurrent caused by a power surge occurring on the primary side of the transformer is likely to be transferred to the secondary side through the transformer and serially destroy the overall electronic device system. In particular, electronic devices including tuner receivers, such as televisions, DVD players, or the like, that have an input power supply connected to equipment such as an antenna, exposed to a lightning strike, may be easily exposed to a power surge caused by a lightning strike, or other event.

Thus, in a case in which an electronic device including a tuner receiver is provided to use the power supply apparatus 100 including the flyback converter, it is necessary to establish sufficient insulation between the primary side and the secondary side of the transformer included in the power supply apparatus 100 and take power surge prevention measures. In this regard, to effectively prevent circuit parts from deteriorating and being destroyed due to a power surge caused by a lightning strike or another factor, there is a need to consider power surge voltage/current paths that are different from each other in a differential mode and a common mode on the assumption of a condition that the power surge occurs at a point having a peak level value of the alternating current power signal.

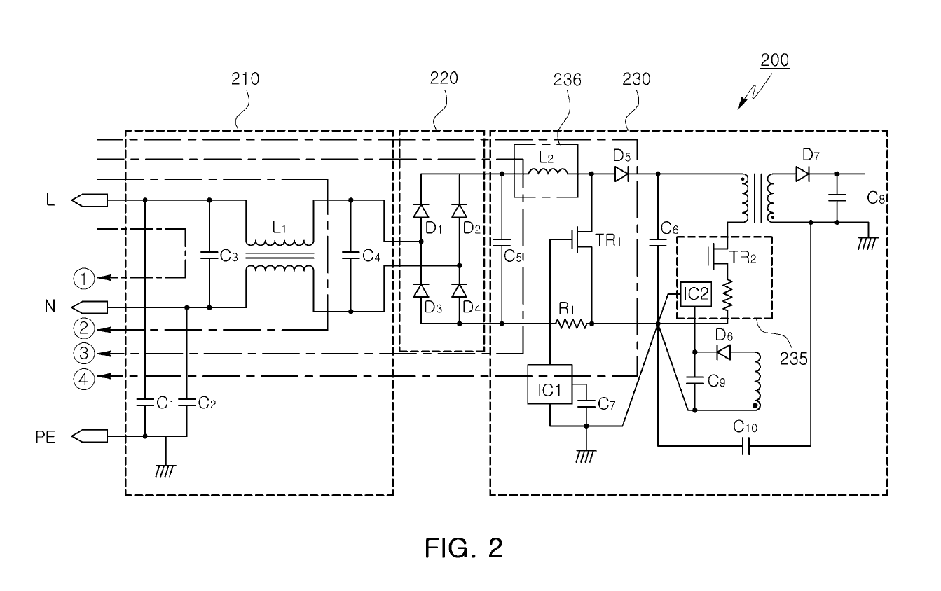

FIG. 2 is a circuit diagram of a signal path of overvoltage or overcurrent that may occur in a power supply apparatus 200 including an overvoltage protection function according to an embodiment of the present invention.

Referring to FIG. 2, the power supply unit 210 receives an alternating current power from a live line L, a neutral line N, and a protective earth (PE), and applies the alternating current power to the rectification unit 220 through a plurality of capacitors C₁˜C₄ and a common choke inductor L1. As described above, the rectification unit 220 may include a plurality of diodes D₁˜D₄, generate a direct current signal by rectifying and smoothing the alternating current power output by the power supply unit 210, and input the direct current signal to the main circuit unit 230.

In the embodiment of FIG. 2, a PFC converter and a flyback converter are included in the main circuit unit 230. The PFC converter may include a transistor TR1 functioning as a switching device, a voltage boosting inductor 236, and an integrated circuit part IC1. The flyback converter may include a plurality of transistors TR1 and TR2 functioning as switching devices, the transformer 235 and integrated circuit parts IC1 and IC2. When the transistor TR2 connected to a primary side of the transformer 235 is turned on, current flows through the primary side winding of the transformer 235, and thus voltage is induced to the primary side winding. Meanwhile, voltage having an opposite polarity to that of the voltage induced to the primary side winding is induced to a secondary side winding, and thus reverse biased voltage is applied to a diode D₇, and the diode D₇ is blocked. Thus, energy is only accumulated in the primary side winding.

To the contrary, when the transistor T2 is turned off, no current flows through the primary side winding of the transformer 235, and voltage having an opposite polarity to that of the voltage induced to the primary side winding provided when the transistor TR2 is turned on is induced to the secondary side thereof. Thus, forward biased voltage is applied to the diode D₇ and the diode D₇ is conductive, and energy accumulated in the primary side winding of the transformer 235 is discharged to an output terminal through the secondary side winding.

Meanwhile, current paths \textcircled{1}˜\textcircled{4}, shown in FIG. 2 are paths through which an overcurrent occurring due to a power surge caused by a lightning strike or another factor can flow in a differential mode. The current path \textcircled{1} is an overcurrent path between the neutral line N and the live line L of the power supply unit 210 due to the power surge. The current path \textcircled{2} is an overcurrent path that passes through the capacitor C₄ via the common choke inductor L1 of the power supply unit 210.

Further, the current path \textcircled{3} is an overcurrent path via the rectification unit 220. The current path \textcircled{4} is an overcurrent path that passes through a capacitor C₆ connected to the primary side of the transformer 235 of the flyback converter of the main circuit unit 230. In this way, overcurrent may flow between the live line L and the neutral line N of the power supply unit 210 according to a power surge that may occur due to a lightning strike or another factor in the differential mode. To solve the power surge, varistors may be connected between three types of terminals of the input alternating current power supply.

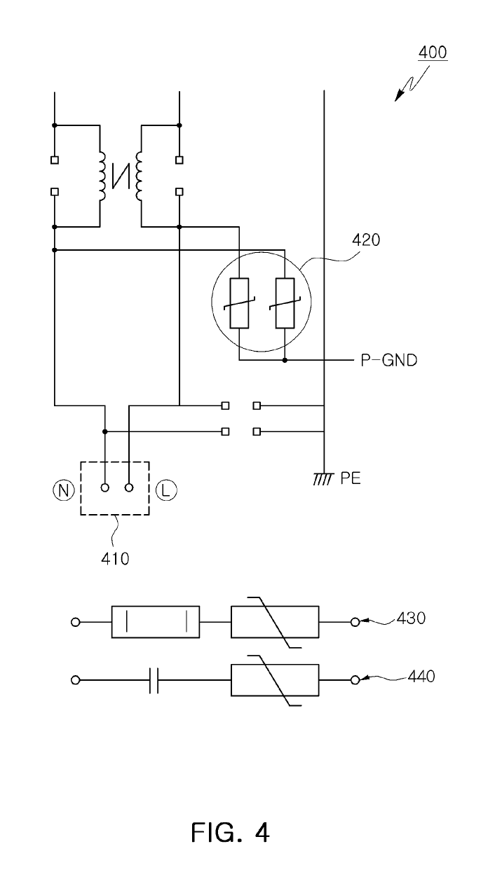

In particular, in the present embodiment, overcurrent/overvoltage due to the power surge caused by a lightning strike or another factor may be reduced by connecting varistors between the live line L of the alternating current power input into the power supply unit 210 and the PE or between the neutral line N and the PE. This will be described with reference to FIG. 4 later.

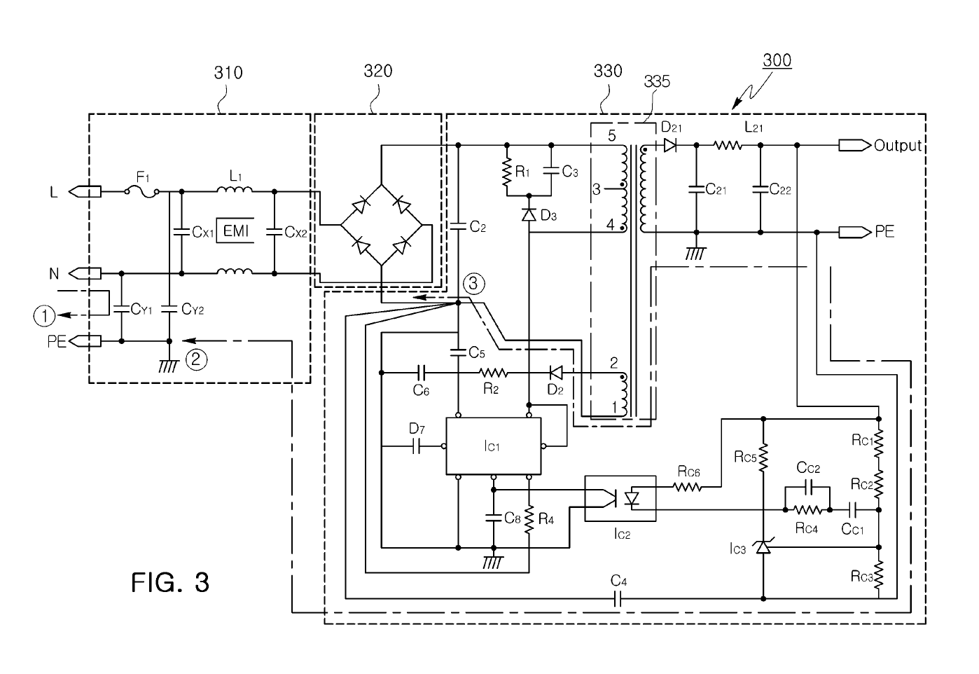

FIG. 3 is a circuit diagram of a signal path of overvoltage or overcurrent that may occur in a power supply apparatus 300 including an overvoltage protection function according to an embodiment of the present invention. The power supply apparatus 300 of FIG. 3 may be generally similar to the power supply apparatus 200 of FIG. 2 and may include a power supply unit 310, a rectification unit 320, and a main circuit unit 330.

The power supply unit 310 receives alternating current power from the live line L, the neutral line N, and a PE. A fuse F1 used to protect a whole system when overvoltage is applied may be connected to the live line L. The alternating current power output by the power supply unit 310 is smoothed, rectified, and converted into a direct current signal by the rectification unit 320 that includes a plurality of diodes (for example, diode bridges). The direct current signal is applied to the main circuit unit 330.

The main circuit unit 330 may include a flyback converter circuit similarly as shown in FIG. 2. The integrated circuit part IC1 for controlling an operation of the main circuit unit 330 may be disposed on a primary side with respect to a transformer 335 included in the flyback converter circuit. FIG. 3 shows three types of overcurrent paths formed according to a power surge that may occur in a common mode.

A first overcurrent path \textcircled{1} is formed between the neutral line N of the input alternating current power and the PE. Finally, it is difficult to sufficiently prevent the power surge occurring along the first overcurrent path \textcircled{1} of FIG. 3 by using varistors that are connected between the neutral line N and the live line L to generally reduce overcurrent/overvoltage. Thus, to efficiently reduce the first overcurrent path \textcircled{1}, varistors may be directly connected between the neutral line N and the PE.

A second overcurrent path \textcircled{2} is a current path from a PE of an output end to a PE of an input end through the capacitor C₄. The second overcurrent path \textcircled{2} is a path along which current is transferred through the coupling capacitor C₄ between the primary side and a secondary side of the transformer 335. Thus, the primary side and the secondary side of the transformer 335 are not sufficiently insulated through the second overcurrent path \textcircled{2}, and a power surge occurring on one of the primary side and the secondary side of the transformer 335 may be transferred to another side, which may lead to serial damage of circuit parts.

Such a phenomenon may take place through overcurrent paths \textcircled{3} and \textcircled{4}. The overcurrent path \textcircled{3} is formed by an equivalent parasitic capacitor between a PE of the primary side and a PE of the secondary side of the transformer 335. The overcurrent path \textcircled{4} is formed through a line B+ of the primary side and the PE of the secondary side of the transformer 335. Likewise to the case of the second overcurrent path \textcircled{2}, overcurrent due to the fact of a power surge occurring between the primary side and the secondary side of the transformer 335 may be transferred to another side through the overcurrent paths \textcircled{3} and \textcircled{4}, and thus it is necessary to establish sufficient insulation between the primary side and the secondary side of the transformer 335.

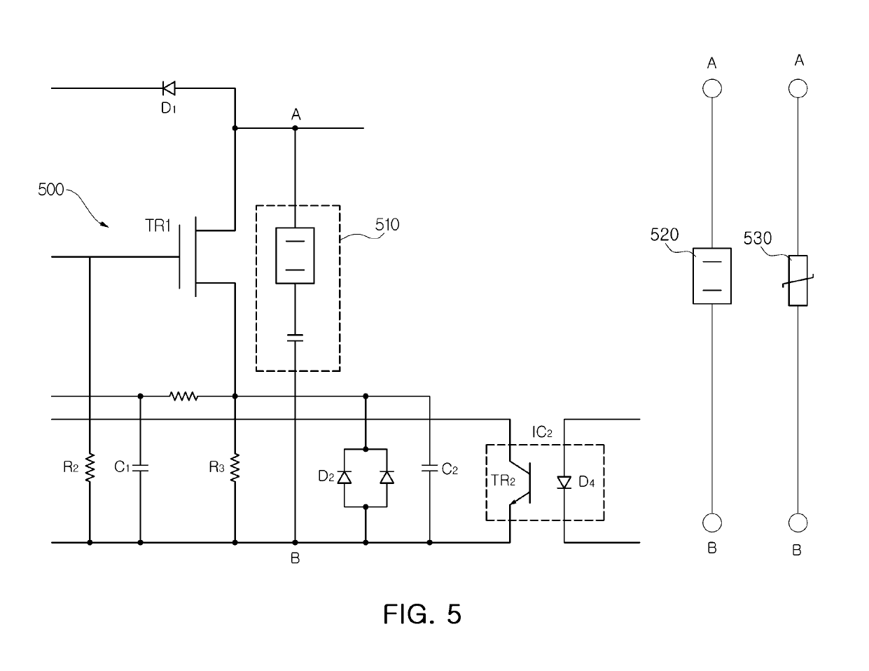

In the present embodiment of the present invention, a power surge caused by a lightning strike or another factor may be reduced by connecting varistors or arrestors and capacitors to a switching device connected to the primary side of the transformer 335. This will be described with reference to FIG. 5 later.

FIGS. 4 and 5 are schematic circuit diagrams of examples of an overvoltage blocking unit included in a power supply apparatus including an overvoltage protection function according to embodiments of the present invention.

Referring to FIG. 4 showing an input unit 400, input alternating current power 410 moves along the live line L and the neutral line N, and varistors 420 are disposed between the live line L of the input alternating current power 410 and a protective earth P-GND and between the neutral line N thereof and the P-GND, respectively. The varistors 420 may reduce a power surge caused by a lightning strike or another factor that may strike a tuner receiver such as an antenna connected to the input alternating current power 410, or the like, and thus the tuner receiver, etc. blocks overcurrent or overvoltage that may be transferred to an entire system through a power supply apparatus such as an SMPS apparatus and the like.

Although the varistors 420 of FIG. 4 are connected between the live line L of the input alternating current power 410 and the P-GND and between the neutral line N thereof and the P-GND, the varistors 420 may be selectively connected between the live line L of the input alternating current power 410 and the PE P-GND or between the neutral line N thereof and the PE P-GND. However, considering that the power surge may occur between the live line L and the neutral line N in a differential mode, and the surge may occur between the neutral line N and the P-GND in a common mode, the input unit 400 may include two varistors.

Alternatively, as shown in FIG. 4, in a case in which capacitors are connected to the varistors 420 in series or arrestors are connected thereto in series, an effect similar to that obtained by placing the varistors 420 between the live line L of the input alternating current power 410 and the P-GND and between the neutral line N thereof and the P-GND, respectively, may be expected.

Next, referring to FIG. 5, an overvoltage blocking unit 510 including an arrestor and a capacitor is connected between a drain terminal and a source terminal of the transistor TR1 that is included in a main circuit unit 500 and functions as a switching device. As an example, the transistor TR1 of FIG. 5 may be the switching device that is connected to a primary side of a transformer of a flyback converter included in the main circuit unit 500 and controls current flowing through the primary side winding of the transformer. That is, when the transistor TR1 is turned on, energy is accumulated in the primary side winding of the transformer of the flyback converter, and, when the transistor TR1 is turned off, the energy accumulated in the primary side winding of the transformer may be transferred and output to a secondary side winding of the transformer.

Alternatively, as shown in FIG. 5, an arrestor 520 may be connected to both ends of the transistor TR1 or a varistor 530 may be connected thereto without a capacitor. In a case in which the arrestor 520 or the varistor 530 is only connected to the overvoltage blocking unit 510, an effect similar to that of the overvoltage blocking unit 510 in which the arrestor and the capacitor are in series connected can also be expected.

As set forth above, according to embodiments of the invention, a path along which an overvoltage, an overcurrent or the like occurring due to a power surge caused by a lightning strike can flow may be obtained by connecting varistors between a live line of an input power supply and a ground or between a neutral line thereof and the earth, or the varistors, an arrestor, etc. may be connected to a switch device of a primary side of a transformer included in a circuit, thereby reduce levels of overvoltages and overcurrents. Whereby, pressure resistance characteristics with respect to the power surge caused by a lightning strike or the like may increase, and a defect rate of a whole circuit may be reduced, thereby increasing yield and promoting an increase in a competitive price.

While the present invention has been shown and described in connection with the embodiments, it will be apparent to those skilled in the art that modifications and variations can be made without departing from the spirit and scope of the invention as defined by the appended claims.

What is claimed is:

1. A power supply apparatus including an overvoltage protection function, the power supply apparatus comprising:
a power supply unit supplying a predetermined input power supply;
a rectification unit generating a first power supply by rectifying the input power supply;
a main circuit unit generating a second power supply from the first power supply; and
an overvoltage blocking unit blocking overvoltages and overcurrents,
the overvoltage blocking unit including varistors connected between at least one of a live line and a neutral line of the input power supply and a ground.

2. The power supply apparatus of claim 1, wherein the overvoltage blocking unit includes a first varistor connected between the live line of the input power supply and a protective earth and a second varistor connected between the neutral line of the input power supply and the protective earth.

3. The power supply apparatus of claim 1, wherein the overvoltage blocking unit forms a discharge path and reduces power surge voltage caused by a lightning strike.

4. The power supply apparatus of claim 1, wherein the main circuit unit includes a flyback converter including at least one transformer.

5. The power supply apparatus of claim 4, wherein the overvoltage blocking unit includes a circuit connected between a drain terminal and a source terminal of a switching device disposed on a primary side of the at least one transformer, and controlling the overvoltages.

6. The power supply apparatus of claim 5, wherein the circuit connected between the drain terminal and the source terminal and controlling the overvoltages includes at least one of a varistor, an arrestor, and a capacitor.

7. A power supply apparatus including an overvoltage protection function, the power supply apparatus comprising:
a power supply unit supplying a predetermined input power supply;
a main circuit unit including at least one transformer and generating output power supply from the input power supply; and
an overvoltage blocking unit blocking overvoltages and overcurrents,
the overvoltage blocking unit including at least one of a varistor, an arrestor, and a capacitor to control overvoltages and overcurrents transferred to a switching device included in a primary side of the at least one transformer.

8. The power supply apparatus of claim 7, wherein the overvoltage blocking unit includes at least one of the varistor, the arrestor, and the capacitor that are connected between a drain terminal and a source terminal of the switching device included on the primary side of the at least one transformer.

9. The power supply apparatus of claim 7, wherein the main circuit unit includes a flyback converter circuit.

10. The power supply apparatus of claim 7, wherein the overvoltage blocking unit forms a discharge path and reduces a power surge voltage caused by a lightning strike when a power surge occurs due to the lightning strike.

11. The power supply apparatus of claim 7, wherein the overvoltage blocking unit blocks a power surge current or the power surge voltage from being transferred between the primary side and a secondary side of at least one transformer when the power surge occurs due to the lightning strike.

12. The power supply apparatus of claim 7, wherein the overvoltage blocking unit includes varistors connected between at least one of a live line and a neutral line of the input power supply and a ground.

13. The power supply apparatus of claim 12, wherein the overvoltage blocking unit includes a first varistor connected between the live line of the input power supply and a protective earth and a second varistor connected between the neutral line of the input power supply and the protective earth.
